(19) United States
(12) Patent Application Publication
(10) Pub. No.: US 2009/0174664 A1
(43) Pub. Date: Jul. 9, 2009

(54) PROJECTION DEVICE WITH TOUCH SENSITIVE KEYPAD

(75) Inventor: Danny Han, Happy Valley, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: InFocus Corporation, Wilsonville, OR (US)

(21) Appl. No.: 12/348,228

(22) Filed: Jan. 2, 2009

Related U.S. Application Data
(60) Provisional application No. 61/019,100, filed on Jan. 4, 2008.

(51) Int. Cl. G09G 5/00; H04N 5/64

(52) U.S. Cl. 345/168; 348/744

(57) ABSTRACT

A projection device that includes a plurality of touch sensitive buttons, a backlight system for selectively illuminating each of the plurality of touch sensitive buttons, and a control device configured to control the backlight system to vary illumination of the plurality of touch sensitive buttons as a projection device operating state varies.

### CROSS-REFERENCE TO RELATED APPLICATIONS

This application claims priority from U.S. Provisional Patent Application Ser. No. 61/019,100 of Danny Han, for TOUCH SENSITIVE KEYPAD, filed Jan. 4, 2008, the disclosure of which is hereby incorporated by reference in its entirety and for all purposes.

### BACKGROUND

Projection devices may be used in various settings to display video imagery. For example, a projection device may be used in an office setting, such as a conference room, to display a presentation. As another example, a projection device may be used to in a home setting, such as a theatre room, to display a movie. Each different setting may have different conditions that may affect video imagery displayed by the projection device. For example, different settings may have different levels of ambient light, such as bright conditions that may cause the displayed video imagery to appear washed out or faced, or low light conditions that may cause the displayed video imagery to appear dark or dim. As another example, a projection device may be positioned differently in different settings, such as on a table or a stand, the projection device may display video imagery at varying distances and heights that may cause keystone issues, or a projection device may be mounted to a ceiling which may cause display inversion issues.

In order to accommodate these issues, a projection device may include a plurality of buttons that facilitate adjustment of different aspects of projection as well as adjustment of operational settings of the projection device. In one particular example, a projection device includes twelve mechanical buttons arranged in a keypad. The keypad is oriented on a surface of the projection device so that a user may adjust various aspects of projection and other settings of the projection device.

However, a user may be intimidated or confused by the visual aspect of such a large number of buttons. In particular, with such a large number of buttons visibly available to the user at one time, the user may not know which particular button to push to adjust a certain aspect of projection or setting and therefore may be reluctant to make adjustments to the projection device.

Furthermore, mechanical buttons arranged in a keypad on a surface of the projection device may be less aesthetically pleasing to a user of the projection device. In particular, the mechanical buttons may protrude from the surface of the projection device and may be made of a different type of material than that of the surface of the projection device. The visual and tactile differences of mechanical buttons as compared to the surface of the projection device may be noticeably different and may reduce the aesthetic appeal of the projection device. The visual differences between the mechanical buttons and the projection device surface may be most noticeable and least appealing in a projection device that has a smooth and sleek surface which may visually differ from the plastic or rubber surface of mechanical buttons.

### SUMMARY

Accordingly, various embodiments of a projection device including touch sensitive buttons are described below. For example, one embodiment of a projection device includes a plurality of touch sensitive buttons, a backlight system for selectively illuminating each of the plurality of touch sensitive buttons, and a control device configured to control the backlight system to vary illumination of the plurality of touch sensitive buttons as a projection device operating state varies.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an exemplary embodiment of a projection device having an embodiment of a touch sensitive keypad.

FIG. 2 shows a cross section view of the touch sensitive keypad of FIG. 1.

FIG. 3 shows the touch sensitive keypad of FIG. 1 in a first state where only a power button is illuminated.

FIG. 4 shows the touch sensitive keypad of FIG. 1 in a second state where multiple buttons are illuminated.

FIG. 5 shows another embodiment of a touch sensitive keypad operating in a first mode.

FIG. 6 shows the touch sensitive keypad of FIG. 5 operating in a second mode.

FIG. 7 shows an embodiment of a projection device having a touch sensitive keypad that is selectively illuminated based on a mounting orientation of the projection device.

FIG. 8 shows a flow diagram of an embodiment of a method for illuminating a plurality of touch sensitive buttons of a projection device according to different lighting schemes that correspond to different operating states of the projection device.

### DETAILED DESCRIPTION

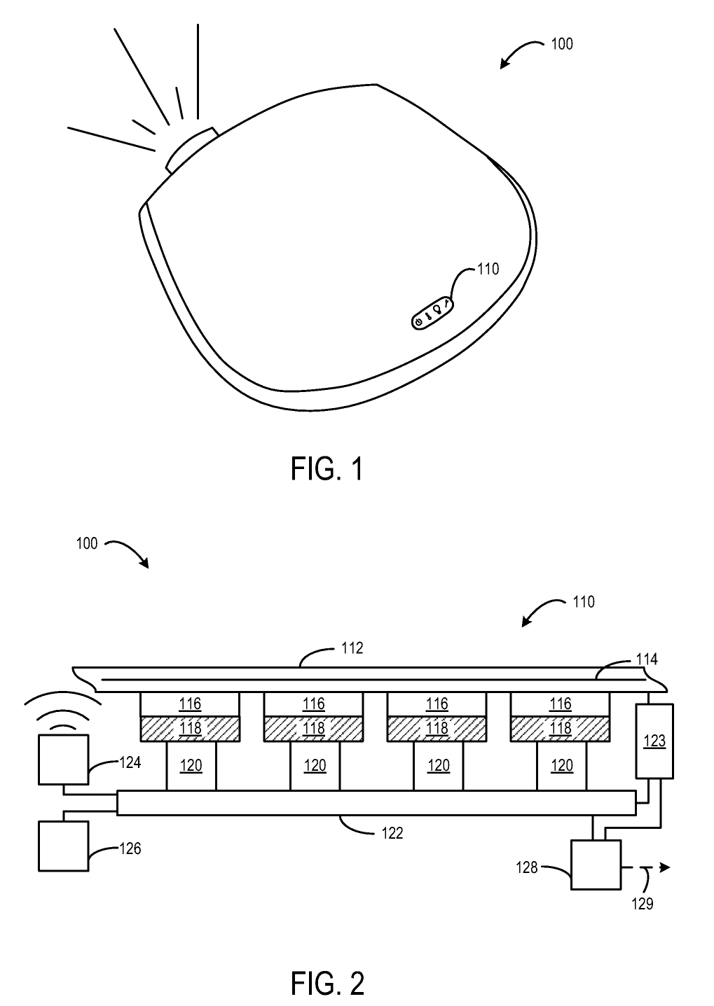

FIG. 1 shows an exemplary embodiment of a projection device 100. Projection device 100 may be any suitable device for projecting video imagery, such as for example, a front projection device that projects an image to a remote viewing surface. Projection device 100 may include a touch sensitive keypad 110. Touch sensitive keypad 110 may be located in a back region of a top surface of projection device 100 so that the touch sensitive keypad may be easily viewable and accessible by a user of the projection device. However, it will be appreciated that the touch sensitive keypad may be located in any suitable region and/or surface of the projection device.

Touch sensitive keypad 110 may include a plurality of touch sensitive buttons configured to be activated in response to being touched by a user. Each of the buttons of touch sensitive keypad 110 may control a different aspect of functionality of projection device 100 and/or may facilitate navigation between different settings of the projection device. Each button may include a different icon viewable by a user that indicates the functionality of the respective button. It will be appreciated that the buttons of the keypad may include any suitable icon to indicate the type of functionality to which the button controls.

The touch sensitive keypad and/or touch sensitive buttons may be visible via backlighting that may selectively illuminate the touch sensitive buttons according to a lighting scheme. Further, one or more buttons may be differentiated from other buttons by different backlit colors that may be dictated by the lighting scheme. For example, each button of the touch sensitive keypad may be illuminated by a different color. As another example, a first set of touch sensitive buttons corresponding to adjustment of a first projection device setting may have the same color back light while other touch sensitive buttons or sets of touch sensitive buttons corresponding to adjustment of a second projection device setting may have a different color backlight. Further still, in some cases, one or more buttons may change a backlight color based on an operating condition or operating state of the projection device.

For example, during a display settings operating state where settings (e.g., brightness, tint, contrast, etc.) that transform the presentation of a projected image may be adjusted, a set of buttons useable to adjust the display settings may be illuminated in a first color to indicate that those particular buttons are usable during the display settings operating state. During a second operating state, for example a projection device setup operating state, one or more of the set of buttons may be illuminated in a second color that is different from the first color to indicate that those buttons are usable during the projection device setup operating state. Note that some touch sensitive buttons illuminated in the first operating state need not be illuminated during the second operating state. Further, note that touch sensitive buttons that were not illuminated during the first operating state may become illuminated during the second operating state.

Projection device 100 may be designed to be aesthetically pleasing. As such, the top viewable surface of projection device may be glossy, and/or polished to appear smooth and sleek. In one particular example, the top surface may be substantially continuous and may include a layer of tinted clear polycarbonate. To complement the aesthetic design of the projection device, the touch sensitive keypad may be positioned flush with the top surface of the projection device. In some cases, the touch sensitive keypad may be integral or located below the surface layer of the projection device. Since the touch sensitive keypad may be flush with, integrated, or below the surface of the projection device there may not be any tactile difference between the region of the touch sensitive keypad and other regions of the top surface of the projection device.

However, it will be appreciated that in some embodiments, the touch sensitive keypad may have a tactility that differs from the top surface of the projection device. For example, the surface may include shallow depressions or ridges to indicate a touch sensitive button. As another example, the keypad or buttons may have a dull or rough surface to differentiate from the smooth or glossy finish of the surface of the projection device. The touch sensitive keypad need not include any mechanical buttons that cause a break or protrusion in the surface of the projection device, although such buttons may be included in some embodiments.

FIG. 2 shows a cross-sectional view of touch sensitive keypad 110 of projection device 100. Touch sensitive keypad 110 may include a plurality of touch sensitive buttons 116 located below a surface 112 of the projection device. In some embodiments, the touch sensitive buttons 116 may be flush with or incorporated into surface 112. The surface 112 may act as a protective layer for touch sensitive buttons 116. In particular, since the touch sensitive buttons are not mechanical buttons the surface does not need to include break(s) through which to allow access to control the buttons. The lack of break(s) in the surface results in improvement in strength and stability of the projection device surface. As such, touch sensitive keypad 110 may be more resistant to damage relative to a keypad having mechanical buttons that protrude through break(s) in a keypad/projection device surface.

Touch sensitive buttons 116 may be capacitive and thus may be activated in response to being touched by a user. In particular, surface 112 may include a conductive material 114 that upon being touched by a user may alter an electrical field of the material resulting in a change in capacitance. The change in capacitance of the region of the surface of the keypad corresponding to a particular button may be used as an activation signal for the button. An activation signal from conductive material 114 that corresponds to a selected button may be referred to herein as an activation signal generated by, or received from, the button.

The activation signal may be sent to a printed circuit board (PCB) 122 and/or control device 123. Control device 123 may include processing and storage to execute control operations based on the received activation signals. For example, in response to receiving an activation signal from a touch sensitive button, control device 123 may transform a corresponding aspect of projection device functionality including changing a state of operation of the projection device, adjusting a projection device setting, and/or performing a projection device operation. In one example, control device 123 receives an activation signal for one of the plurality of touch sensitive buttons 116, processes the activation signal, and controls projection system 128 to transform an image projected by projection electronic 128 based on the aspect of projection device functionality controlled by the touch sensitive button associated with the received activation signal.

Projection system 128 may be configured to receive image data from a video source (not shown) and process the image data to generate a projected image 129. In one particular example, projection system 128 includes a light source (e.g., a lamp) that directs light through an image generation device (e.g., a light valve, a digital micromirror device (DMD), etc.). The image generation device utilizes received image data to manipulate the light from the light source to form an image. Once formed, the image is routed through optics (e.g., lens) so that the image is suitable for projection. Various aspects of projection system 128 may be adjusted responsive to touch input of touch sensitive buttons 116. For example, optics may be adjusted to correct keystoning of a projected image. As another example, control of the image generation device may be adjusted to change a display setting output by the image generation device.

The touch sensitive keypad may include different materials or different circuit configurations in the surface of the keypad region so that different capacitive signals may be generated to indicate activation of different buttons of the keypad. For example, material 114 may be arranged into a plurality of different circuits corresponding to each button of the keypad.

It will be appreciated that in some embodiments other suitable technologies may be implemented to detect touching of the touch sensitive keypad. For example, resistive, surface acoustic wave, dispersive signal, infrared or other optical imaging technologies may be used to detect a touch of the touch sensitive keypad and/or buttons.

Continuing with FIG. 2, each of touch sensitive buttons 116 may be selectively illuminated by a backlight system 120. In the illustrated embodiment, backlight system 120 includes one or more multi-colored light emitting diodes (LED) which may be mounted on PCB 122 or other control device. In particular, when illuminated, LEDs 120 may shine light which may be reflected through light pipes/diffusers 118 to touch sensitive buttons 116. In another example, LEDs 120 direct light downward and the light is reflected back up by light pipes/light diffusers 118. In these configurations, light from the LEDs may be diffused evenly across each button/keypad and hot spots on the keypad may be reduced or minimized. It will be appreciated that a light diffuser may be provided for each touch sensitive button to diffuse light generated by one or more associated LEDs (e.g., LEDs of different colors) evenly across the touch sensitive button. The separate light diffusers may permit each touch sensitive button to be illuminated evenly in a color different from the other touch sensitive buttons. In some embodiments, a light diffuser may diffuse light for more than one touch sensitive button.

Furthermore, since the keypad and buttons may be positioned below a top surface and the buttons need not be mechanically actuated; there may be minimal or no tactile response when a user touches a particular button of the keypad. Thus, keypad 110 may include a feedback device 124 in communication with PCB 122 and/or control device 123. The control device 123 may control feedback device 124 to produce a human-perceivable signal in response to a button of the touch sensitive keypad being touched by a user. In one example, feedback device 124 is a haptic feedback device that generates vibrations or rumbles to provide feedback that is perceivable by a user. In another example, feedback device 124 is a sound generating device that generates an audio signal to provide feedback that is perceivable by a user. In this configuration, audible feedback may be generated to indicate that a button has been activated, such as a “beep” sound, for example. It will be appreciated that feedback device 124 may produce any suitable human-perceivable feedback to a user to indicate that a button has been touched. Further, it will be appreciated that the feedback device may be activated to indicate activation of other suitable projection device functions, such as switching between different projection settings or projection device operating states, for example.

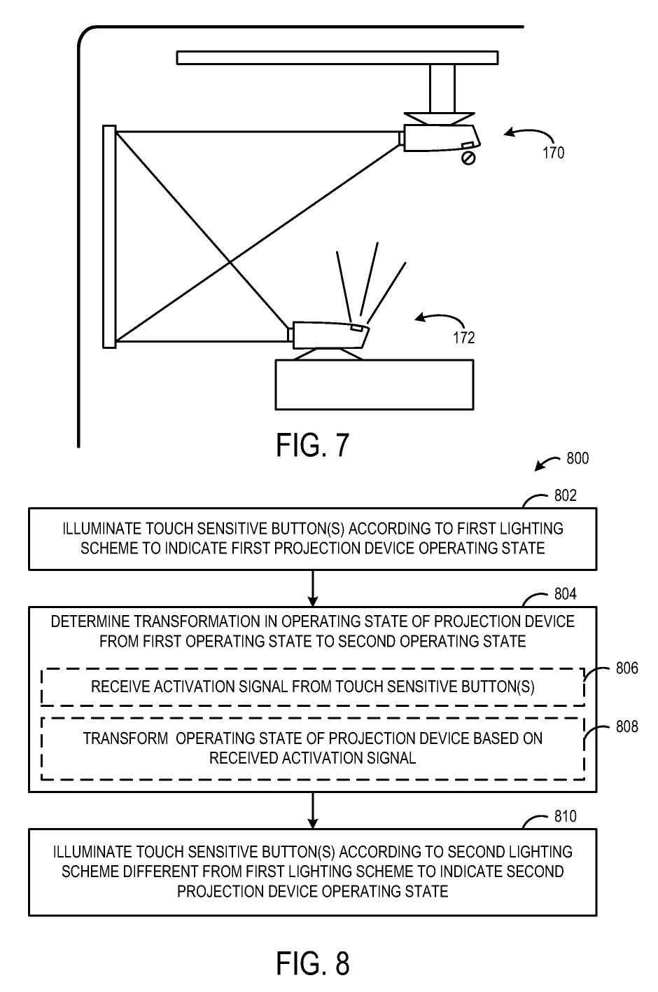

In some embodiments, the touch sensitive keypad may be selectively illuminated based on orientation of the projection device. In particular, the projection device may include an orientation device 126 configured to determine the orientation of the projection device. For example, the orientation device 126 may include an accelerometer or bubble level that provides an indication of projection device orientation. The orientation device 126 may be integrated with or in communication with PCB 122 and/or control device 123 and may send an orientation signal to control device 123 that may be used to automatically control backlight system 120 to selectively illuminate touch sensitive buttons 116. Examples of selective illumination of the touch sensitive keypad based on orientation of the projection device are discussed in further detail below with reference to FIG. 7.

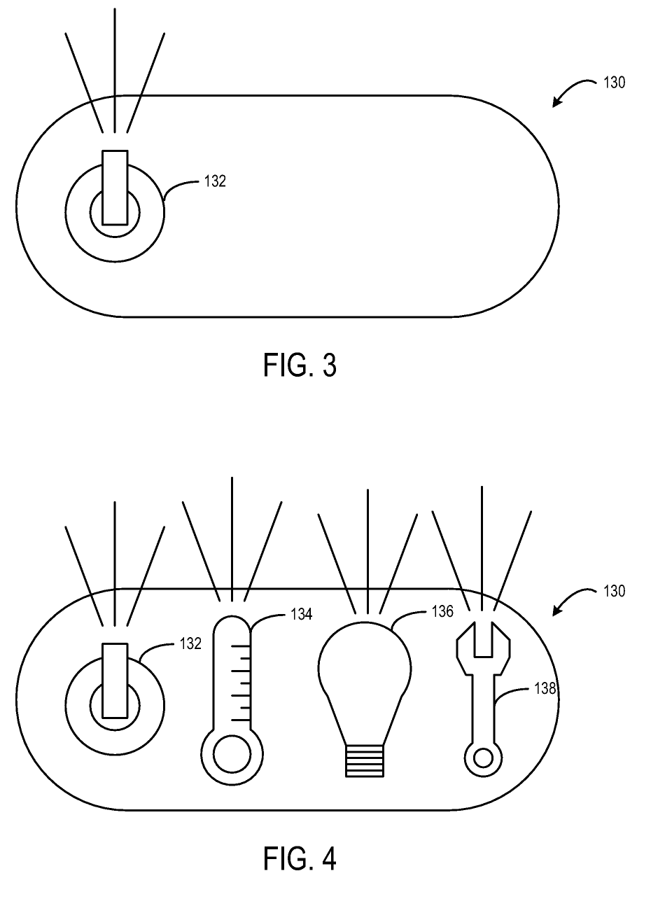

In some embodiments, the touch sensitive keypad may be configured to selectively illuminate different buttons of the touch sensitive keypad to indicate different states of operation of the projection device. FIG. 3 schematically shows an example embodiment of a touch sensitive keypad 130 where only a button having a power icon 132 (i.e. “power button”) is illuminated and other buttons are not visible. In one example, the power button may be illuminated to indicate a state of operation where the projection device is receiving power but is not operating. This operating state may occur when a power cord of the projection device is plugged into an electrical power receptacle and the projection device is not operating. In one particular example, the power icon 132 is illuminated in red when the projection device is not in operation and the power cord is plugged in, and the power icon 132 is illuminated in green when the projection device is in operation.

Note that in some embodiments, operation of a button may be limited to when the button is illuminated. In other words, the control device may ignore activation signal received from non-illuminated touch sensitive buttons. Accordingly, when a user touches a non-illuminated button no inadvertent control adjustment may occur which may result in reduced user error.

Furthermore, upon a user touching the power button, the projection device may be activated and as the projection device initiates startup the other buttons of the touch sensitive keypad may become illuminated. FIG. 4 shows the touch sensitive keypad of FIG. 3 in a second state where the projection device is operating and all of the buttons of the keypad are illuminated. The buttons of the keypad may control adjustment of different aspects of projection device operation. For example, the keypad may include a device setup button represented by a wrench icon 138, a projection display button represented by a light bulb icon 136, and a temperature control button represented by a thermometer icon 134. As discussed above, the buttons of the keypad may be illuminated by different colors. In some embodiments, the different buttons may also operate as indicators of operating conditions. For example, the buttons may change color to indicate a change in operating condition of the projection device. In one particular example, the thermometer icon may change from yellow to red as the internal temperature of the projection device increases. As another example, the light bulb icon may change color to indicate a level of remaining life of a projection lamp of the projection device

Furthermore, in some embodiments, the illumination of a button may change color based on the operating state or mode of operation of the projection device. For example, a setup button may be illuminated by a first color while navigating a device configuration menu and the setup button may be illuminated by a second color while navigating an image projection menu. By changing colors of illumination of the buttons of the touch sensitive keypad based on operating state and/or mode of the projection device, a user may be presented with a clear visual indicator of the change so that the user is less intimidated and more willing to operate and adjust the projection device.

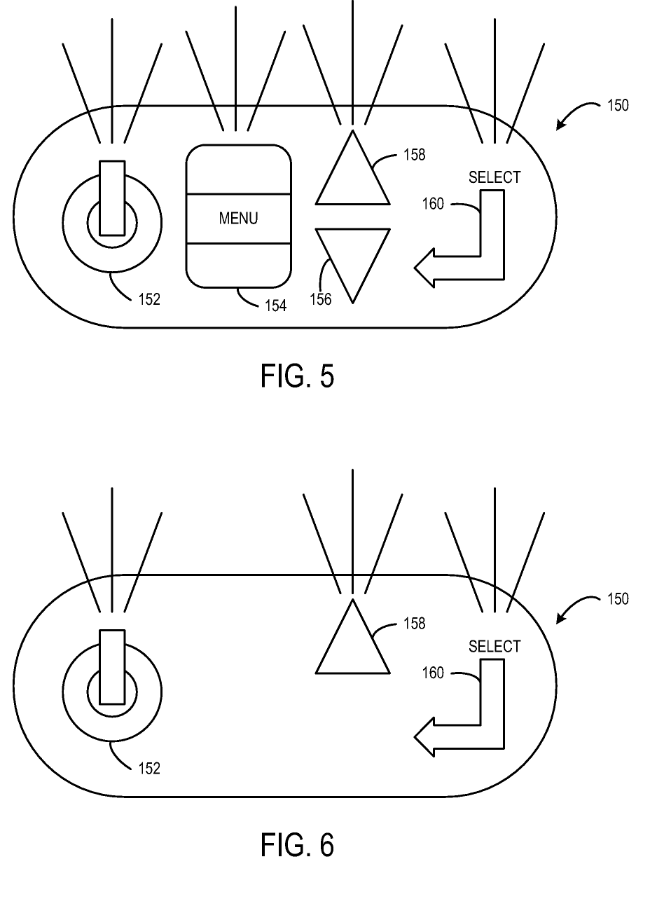

FIGS. 5-6 schematically show another example embodiment of a touch sensitive keypad having touch sensitive buttons configured to be selectively illuminated based on the operational usefulness of the button during different adjustment and control operations. In other words, a button may be only illuminated if it can be used for adjustment or navigation of a currently selected operation. FIG. 5 shows a state where all of the buttons of keypad 150 are illuminated. Keypad 150 may include power button 152, menu button 154, “down” navigation button 156, “up” navigation button 158, and select button 160. In one example, all of buttons 152-160 of keypad 150 may be illuminated when the projection device is in a main menu state where operations of buttons 152-160 are currently activatable and/or applicable to control of the projection device.

FIG. 6 shows keypad 150 in a second state where only selected buttons are illuminated based on a particular operation of the projection device. In particular, only power button 152, “up” navigation button 158, and select button 160 are illuminated and applicable to control adjustment of the projection device. In one example, this combination of buttons are illuminated when a user has navigated to the bottom selection of a particular menu and the user's only options are to navigate up the menu, select the current menu selection, or to turn off the projection device. It will be appreciated that the other buttons are not illuminated since they have no applicability to the current state of projection device operation. By selectively illuminating buttons of the touch sensitive keypad based on operational usefulness, the buttons are not visible or touchable unless applicable to the current operation. In this way, the touch sensitive keypad may be perceived by a user as simplified and less intimidating to operate and user error may be reduced.

Note that an exemplary touch sensitive keypad may include any suitable number of touch sensitive buttons. The touch sensitive buttons may be selectively illuminated based on various states of operation of the projection device and applicability of the respective button to control operation of the projection device. Further, the touch sensitive buttons may selectively change color of illumination to indicate a change in operating state of the projection device.

As discussed above, in some embodiments, the touch sensitive keypad or selected buttons included therein may be selectively illuminated based on orientation of the projection device. FIG. 7 shows two examples of projector orientation. In a first orientation 170, when a projection device is mounted to a ceiling and positioned upside down, a user may seldom use the keypad to adjust operation of the projection device. Accordingly, the touch sensitive keypad may be configured such that the backlight feature of the keypad is turned off (or dimmed) to hide the keypad when the projector is in an inverted orientation so that the illumination of the touch sensitive keypad does not interfere with viewing of the projected image. Moreover, with no illumination, the buttons of the keypad are not visible to distract the viewer when the keypad is not needed for adjustment. Accordingly, the aesthetic value of the projection device may be improved.

In one example, the keypad may automatically turn-off the backlight feature and may include a device to detect the orientation of the projection device and may activate/deactivate the backlight based on the device. As discussed above with reference to FIG. 2, in one particular example, an orientation device 126 may be integrated or in communication with the PCB 122 and/or control device 123, such as an accelerometer or a bubble level, for example. In another example, the keypad may include a backlight toggle switch or selectable feature that may be selected by a user to turn off the backlight feature for ceiling mounted operation.

In a second orientation 172, when a projection device is oriented upright (or right side up) and positioned away from the ceiling, a user may interact with the touch sensitive keypad more frequently. Accordingly, the touch sensitive keypad may be configured such that the backlight feature of the keypad is turned on to illuminate the keypad when the projector is in an upright orientation. In one particular example, the orientation device determines that the projection device is in an upright orientation and sends a corresponding signal to the control device. In response to receiving the signal, the control device controls the backlight system to illuminate the touch sensitive keys of the keypad so that they are visible to the user.

It will be appreciated that some or all of the touch sensitive buttons of the touch sensitive keypad may be selectively illuminated based on the projection device being placed in an orientation other than the example orientations described above. For example, the touch sensitive keypad may be placed in an unlit or non-illuminated state when the projection device is positioned to project an image on a floor/ceiling (e.g., positioned approximately perpendicular to the floor/ceiling). As such, the keypad may be unlit so as not to distract a viewer of the projected image and to improve the aesthetic value of the projection device by providing a projection device surface free of lit buttons.

In some embodiments, the touch sensitive buttons may be not illuminated or dimmed to hide the touch sensitive buttons when not in use and may be illuminated in response to being touched. For example, the touch sensitive buttons may be dimmed or the illumination state may be turned off after a predetermined period of time without being touched by a user.

FIG. 8 is a flow diagram of an embodiment of a method 800 for illuminating touch sensitive buttons of a projection device according to different lighting schemes corresponding to different operating states of the projection device. In one example, method 800 is performed in projection device 100 (shown in FIG. 1). In particular, method 800 is performed by control device 123 (shown in FIG. 2) of projection device 100. The method 800 may begin at 802, where the method may include illuminating the plurality of touch sensitive buttons of the projection device according to a first lighting scheme.

A lighting scheme may include virtually any suitable combination of illuminated (and/or non-illuminated) touch sensitive buttons of the projection device. Non-limiting examples of lighting schemes include illuminating all of the plurality of touch sensitive buttons, illuminating none of the plurality of touch sensitive buttons, and illuminating some of the plurality of touch sensitive buttons.

Moreover, a lighting scheme may assign a color to each of the illuminated touch sensitive buttons. For example, in a first lighting scheme, a first touch sensitive button may be illuminated in a first color and in a second lighting scheme the same touch sensitive button may be illuminated in a different color. As another example, in a first lighting scheme a first set of touch sensitive buttons may be illuminated in one color and in a second lighting scheme the same set of touch sensitive buttons may be illuminated in a different color. As yet another example, in a first lighting scheme a first set of touch sensitive buttons may be illuminated in a first color and in a second lighting scheme a different set of touch sensitive buttons maybe illuminated in the first color. As yet another example, in a first lighting scheme a first set of touch sensitive buttons may be illuminated in a first color and in a second lighting scheme a second set of touch sensitive buttons different from the first set may be illuminated in a second color different from the first color.

At 804, the method may include determining a transformation in operating state of the projection device. In other words, the method may include determining or detecting when a projection device transitions from a first operating state to a second operating state. It will be appreciated that a transformation or change in operating state of the projection device may include transforming an aspect of projection device functionality, such as performing basic control operations (e.g., turning the projection device on/off, adjusting a video input source, etc.) or navigating projection device control menus. Further, transforming an operating state of the projection device may include adjusting a presentation setting (e.g., brightness contrast, keystone correction, etc.) that transforms an aspect of an image projected by the projection device. Further still, transforming an operating state of the projecting device may include adjusting projection device setup (e.g., set language, adjust sound volume, display closed caption, toggle automatic ceiling mount detection).

In some cases, the operating state of the projection device may be transformed responsive to a change in operating condition of the projection device. For example, the projection device may transform from one operating state to another operating state responsive to a change in temperature of the projection device. As another example, the projection device may transform from one operating state to another operating state responsive to a change in the level of usable life of a projection lamp.

In some cases, the operating state of the projection device may be actively transformed based on touch input received via a touch sensitive button. In some embodiments, at 806, the method may include receiving an activation signal from a touch sensitive button. At 808, the method may include transforming the operating state of the projection device responsive to the received activation signal. In other words, the activation signal may dictate transformation from a first operating state to a second operating state.

At 810, the method may include illuminating the touch sensitive button(s) according to a second lighting scheme different from the first lighting scheme to indicate the second projection device operating state of the projection device.

The above described method may be performed to illuminate the touch sensitive keypad, including the touch sensitive buttons, according to a lighting scheme that indicates the operating state of the projection device. In some cases, a lighting scheme may cause only touch sensitive buttons that are applicable for use in the current operating state of the projection device to be illuminated. Accordingly, the touch sensitive keypad may be made less complicated and less intimidating for a user to control operation of the projection device. Moreover, since a particular lighting scheme corresponds to one or more particular operating states of the projection device. a user may easily identify an operating state of the projection device based on the lighting scheme of the touch sensitive buttons. This recognition may result in an improved likelihood of correct operation of the projection device. Furthermore, in some cases, a lighting scheme may dictate that the touch sensitive keypad not be illuminated in order to not distract a user from viewing an image projected by the projection device, such as when the projection device is mounted to a ceiling and oriented upside down, for example.

It will be appreciated that the above described method may be implemented as instructions stored in a storage device (not shown) of projection device 100 and executable by control device 122. In some embodiments, the storage device may be included in the control device.

While disclosed herein in the context of specific example embodiments, it will be appreciated that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. A projection device, comprising:
a plurality of touch sensitive buttons;
a backlight system for selectively illuminating each of the plurality of touch sensitive buttons; and
a control device configured to control the backlight system to vary illumination of the plurality of touch sensitive buttons as a projection device operating state varies.

2. The projection device of claim 1, wherein each of the plurality of touch sensitive buttons generate an activation signal responsive to being touched by a user; and
wherein the control device is configured to receive an activation signal from at least one of the plurality of touch sensitive buttons, transform a projection device operating state responsive to the activation signal, and control the backlight system to illuminate the plurality of touch sensitive buttons according to a lighting scheme that corresponds to the projection device operating state.

3. The projection device of claim 2, wherein transforming the projection device operating state includes adjusting a presentation setting to change an aspect of an image projected by the projection device.

4. The projection device of claim 2, wherein transforming the projection device operating state includes changing an aspect of projection device functionality.

5. The projection device of claim 2, wherein each of the plurality of touch sensitive buttons include a capacitive material having a capacitance that changes in response to being touched by a user, and wherein the activation signal is generated responsive to a change in the capacitance.

6. The projection device of claim 2, further comprising:
a feedback device operatively coupled to the control device; and
wherein the control device is configured to control the feedback device to generate human-perceivable output responsive to receiving the activation signal.

7. The projection device of claim 1, further comprising:
an orientation device operatively coupled to the control device, the orientation device being configured to generate an orientation signal indicating an orientation of the projection device; and
wherein the control device is configured to control the backlight system to selectively illuminate the plurality of touch sensitive buttons based on the orientation of the projection device as indicated by the orientation signal.

8. The projection device of claim 1, wherein the lighting scheme dictates that only touch sensitive buttons that are applicable for use in the current operating state of the projection device are illuminated.

9. The projection device of claim 8, wherein the control device is configured to ignore activation signals received from non-illuminated touch sensitive buttons.

10. The projection device of claim 1, wherein the backlight system comprises
one or more lights and one or more light diffusers, where each light diffuser is configured to diffuse light generated by the one or more of the lights evenly across a corresponding button of the plurality of touch sensitive buttons.

11. The projection device of claim 1, wherein the backlight system is a multi-color backlight system; and
wherein the control device is configured to control the multi-color backlight system to selectively vary a color of at least one of the plurality of touch sensitive buttons as the operating state of the projection device varies.

12. The projection device of claim 11, wherein the control device is configured to control the multi-color backlight system to change a color of at least one of the plurality of touch sensitive buttons to indicate a change in an operating condition of the projection device.

13. A projection device, comprising
a plurality of touch sensitive buttons, each of the plurality of touch sensitive buttons generating an activation signal in response to being touched by a user;
a backlight system for selectively illuminating each of the plurality of touch sensitive buttons; and
a control device configured to control the backlight system to control illumination of the plurality of touch sensitive buttons according to a first lighting scheme to indicate a first operating state of the projection device, in response to receiving the activation signal transform an aspect of projection device functionality to place the projection device in a second operating state, and control the backlight system to control illumination of the plurality of touch sensitive buttons according to a second lighting scheme different from the first lighting scheme to indicate the second operating state of the projection device.

14. The projection device of claim 13, wherein the first operating state includes the projection device being oriented right side up and the first lighting scheme includes illuminating at least one the plurality of touch sensitive buttons and the second operating state includes the projection device being oriented in a position different from right side up and the second lighting scheme includes none of the plurality of touch sensitive buttons being illuminated.

15. The projection device of claim 13, wherein the first lighting scheme includes illuminating a first set of the plurality of touch sensitive buttons and the second lighting scheme includes illuminating a second set of the plurality of touch sensitive buttons different from the first set.

16. The projection device of claim 14, wherein the first lighting scheme dictates that only touch sensitive buttons that are applicable for use in the first operating state are illuminated, and the second lighting scheme dictates that only touch sensitive buttons that are applicable for use in the second operating state are illuminated.

17. The projection device of claim 13, wherein the first lighting scheme dictates that a set of the plurality of touch sensitive buttons are illuminated a first color and the second lighting scheme dictates that the set of the plurality of touch sensitive buttons are illuminated in a second color different from the first color.

18. A front projection device comprising
a plurality of touch sensitive buttons flush with a surface of the projection device, each of the plurality of touch sensitive buttons generating an activation signal in response to being touched by a user;
a plurality of light emitting diodes, each of the plurality of light emitting diodes configured to selectively illuminate at least one of the plurality of touch sensitive buttons;
a plurality of light diffusers, each of the plurality of light diffusers associated with a selected one or more of the plurality of light emitting diodes and a selected one of the plurality of touch sensitive buttons, each of the plurality of light diffusers configured to diffuse light generated by the selected one or more of the plurality of light emitting diodes evenly across the selected one of the plurality of touch sensitive buttons;
an orientation device configured to generate an orientation signal indicating an orientation of the projection device; and
a control device configured to receive an activation signal from at least one of the plurality of touch sensitive buttons, adjust an operating state of the projection device that transforms an image projected to a remote viewing surface by the front projection device responsive to the activation signal, and wherein the control device is configured to control the plurality of light emitting diodes to selectively illuminate the plurality of touch sensitive buttons based on the orientation of the projection device as indicated by the orientation signal.

19. The front projection device of claim 18, wherein the control device is configured to control the plurality of light emitting diodes to not illuminate the plurality of touch sensitive buttons in response to receiving an orientation signal that indicates that the front projection device is oriented upside down.

20. The projection device of claim 18, wherein the control device is configured to control the plurality of light emitting diodes to illuminate only touch sensitive buttons that are applicable for use in the current operating state of the projection device
